(19) United States
(12) Patent Application Publication
(10) Pub. No.: US 2009/0127035 A1
(43) Pub. Date: May 21, 2009

(54) ELECTRIC CART DISC BRAKING SYSTEM

(76) Inventors: Michael R. Wilmouth, San Clemente, CA (US); Doug Barnhold, Fontana, CA (US)

Correspondence Address: GANZ LAW, P.C., P O BOX 2200, HILLSBORO, OR, 97123, US

(21) Appl. No.: 11/944,387

(22) Filed: Nov. 21, 2007

(51) Int. Cl. F16D 55/226

(52) U.S. Cl. 188/72.4

(57) ABSTRACT

An electric cart braking system is shown having a brake cable adapter between the pedal and a hydraulic disk braking system. The method of installing the brake cable adapter and associated components is provided. A kit of components to facilitate in installation of brake cable adapter and associated components is also provided.

### BACKGROUND

Small electrically powered carts are widely used for transportation in conjunction with maintenance and recreation. Such carts are typically seen at golf course and referred to as electric carts. Electric carts are popular because of their low cost, ease of maintenance, quiet operation, and flexibility. As used herein, the term “electric carts” refers to, but is not limited to, electric carts and other similar electric carts that may typically be seen in retirement communities, industrial facilities, stadiums, airports and other places where a full size vehicle is impractical.

The propulsion systems on electric carts usually have one pair of electrically powered motors mounted on the rear axle of the vehicle. Electrical motors have very high torque when energized and this creates rapid acceleration of the electric cart due to the low weight of the vehicle. Unfortunately, quick acceleration of the electric cart also results in high speeds. A consequence of high speeds is the need to stop in a short distance to avoid collisions.

The braking systems of most electric carts manufactured use a drum brake system. A drum brake consists of a set of shoes or pads that press against the inner surface of a rotating drum. The rider in the electric cart actuates the brakes by pressing on a brake pedal, the brake pedal pulls on a cable, which then causes the pads to press, causing friction, resulting in the slowing of the electric cart.

The use of drum brakes on electric carts can have significant disadvantages. The drum brakes require adjustment as the pads wear down. The adjustment process is costly and labor intensive. Drum brakes also suffer from overheating of the material on the brake drum resulting in a phenomenon known as “fade”. The symptoms of fading include the need to further depress the pedal, which can lead to driver panic. Also, the effectiveness of drum brakes diminishes if water, frequently splashed from the ground, enters the drum brake area.

An alternate to drum brakes are disc brakes. Disc brakes operate by forcing friction material, typically brake pads, onto a cast iron or ceramic disc. These types of brakes are typically actuated by hydraulic, mechanical, or electrical methods.

Unfortunately, disc brakes, despite their advantages, have not been installed to any great extent in electric carts. As electric carts have gotten larger, faster, and heavier, the drivers of electric carts with disc brakes have begun to recognize the superior operating characteristics. This has led to a desire to retrofit their existing electric carts that have drum brakes with a disc braking system.

As the electric cart itself is a significant investment for the purchaser of the cart, therefore there is a need to have an existing cart with drum brakes modified with disk brakes. The modification from disk brakes to drum brakes should be done in such a way as to minimize waste. There is also a need to describe the method of installing the conversion kit from drum brakes to disk brakes. Also, there is a need for the conversion components to be delivered in one package so that the installer has all of the components available for the conversion.

### SUMMARY

The inventive subject matter disclosed herein overcomes aforementioned problems in the prior art by

In one possible embodiment the inventive subject matter is directed towards an electric car braking system having a brake cable adapter having a first end and a second end, the first end of the brake cable adapter adapted to be mechanically connected to a pedal, also with a hydraulic disk braking system having a piston input and one or more hydraulic braking elements; the piston input mechanically connected to the second end of the brake cable adapter, and with a pedal that is connected to the brake cable adapter and is depressed, the brake cable adapter is engaged, and the hydraulically operated disk brakes engages the hydraulic braking elements. In this and other embodiments the electric cart braking system has four hydraulic braking elements. In this and other embodiments the electric cart braking system has a brake cable adapter includes a threaded hole that is adaptable to be connected to the pedal. In this and other embodiments the brake cable adapter includes a slotted groove adaptable to be connected to the hydraulic braking system. In this and other embodiments, the electric cart braking system has a hydraulic disk braking system further comprises a master cylinder bracket and a base, the master cylinder bracket having a top portion and a bottom portion, wherein the top portion of the master cylinder bracket is fixedly attachable to a master cylinder and the bottom portion of the master cylinder bracket is attachable to the base. In this and other embodiments the electric cart braking system has a hydraulically operated disk brakes further comprising a first rotor hat assembly and a second rotor hat assembly, the first rotor hat assembly and second rotor hat assembly each having two groups of four sides; the first group four sides is longer and configured in box like structure; and the second four sides is shorter and join the end points of each the first group of four sides; such that a square structure with flattened edges is formed. In this and other embodiments the electric cart braking system has a brake cable adapter with a push rod assembly, wherein the push rod assembly is connectable to the pedal via a brake linkage point, a cylinder linkage point connected to the piston input, and a pivot point, and when the pedal is depressed the brake linkage point is rotated forward causing the cylinder linkage point to rotate about the pivot point causing the piston input to be engaged. In this and other embodiments, the electric cart braking system of claim has first rotor hat assembly and a second rotor hat assembly, the first and second rotor hat assemblies having two groups of four sides; wherein the first group of four sides is longer and is configured in a box like structure; and wherein the second of four sides are shorter and join the end points of each the first group of four sides; such that a square structure with flattened edges is formed.

In another possible embodiment the inventive subject matter is directed towards an electric cart brake modification kit having at least two hydraulic brakes, and a brake cable adapter having one end adaptable for connecting to a pedal and the other end adaptable for connecting to the hydraulic brakes. In this and other embodiments the electric cart brake modification kit has a further a master cylinder mounting plate. In this and other embodiments the electric cart brake modification kit has a rotor hat assembly wherein the edges are modified to round the corner edges for installation on a hub. In this and other embodiments brake kit has four hydraulic brakes. In this and other embodiments the brake kit has a front caliper mount modified by increasing the caliper mount hole.

In another possible embodiment the inventive subject matter is directed towards a method of retrofitting a electric cart braking system that involves removing a drum brake cable interface; removing a drum brakes from an axle; installing a drum brake cable adapter between the pedal and a hydraulic brake system; installing the hydraulic brake system, wherein the hydraulic brake system includes a hydraulic master cylinder and at least two hydraulic disc brakes; and connecting hydraulic brake lines from the hydraulic master cylinder to the hydraulic disc brakes. In this and other embodiments the method of retrofitting a electric cart braking system involving locating the brake cable harness, and the brake cable harness has three attachment points, the attachment points connected to a pedal and each of the drum brakes, and disconnecting first attachment point of the brake cable harness the pedal, and disconnecting the other side of the drum brake cable from the two drum brakes and installing a brake cable adapter, where the brake cable adapter is connected to the pedal and the hydraulic brake system and connecting the first connection point of the brake cable adapter to the pedal, and connecting the second connection point to the hydraulic master cylinder. In this and other embodiments the method of retrofitting an electric cart braking system involves removing a first wheel from an axel and removing a second front wheel from an axel, removing a first unmodified hub from the axel and removing second modified hub from the axle, altering the corner to a planar surface of the first unmodified hub and altering the corner to a flat surface of the second modified hub by transforming the edges from a rounded surface to a planar surface; and installing the first modified hub and the second modified hub on the axle. In this and other embodiments the method of retrofitting an electric cart braking system includes the step of installing four hydraulic brakes. In this and other embodiments the method of retrofitting an electric cart braking system includes the step of installing a push rod assembly between the pedal and the hydraulic brake system. In this and other embodiments the method of retrofitting an electric cart braking system includes the step of installing a front caliper mount on an axle. In this and other embodiments the method of retrofitting an electric cart braking system includes the step of installing a master cylinder mounting assembly.

### BRIEF DESCRIPTION OF THE DRAWINGS

The following figures show various embodiments of the inventive subject matter (except where noted):

FIGS. 1 through 9 show representative embodiments according to the principles of the present inventive concepts.

FIG. 1 is a prior art side view of the electric cart showing the approximately location where the drum brakes are mounted on the electric cart

FIG. 2 is a prior art internal view of the electric cart frame showing the approximate locations of the brake pedal, the brake cables, and the drum brakes.

FIG. 3 is a side view of the installed hydraulic brake system with modifications to the existing drum brake system.

FIG. 4 is an internal view of the installed hydraulic brake system after the existing drum brake system has been removed.

FIGS. 5A, 5B, 5C are views of the master hydraulic cylinder mounting bracket.

FIGS. 6A, 6B, 6C are views of the brake cable adapter.

FIGS. 7A, 7B, 7C are views of the pivot assembly.

FIGS. 8A, 8B is a view of an unmodified and a modified hub.

FIG. 9A, 9B, 9C is a view a push rod assembly.

### DETAILED DESCRIPTION

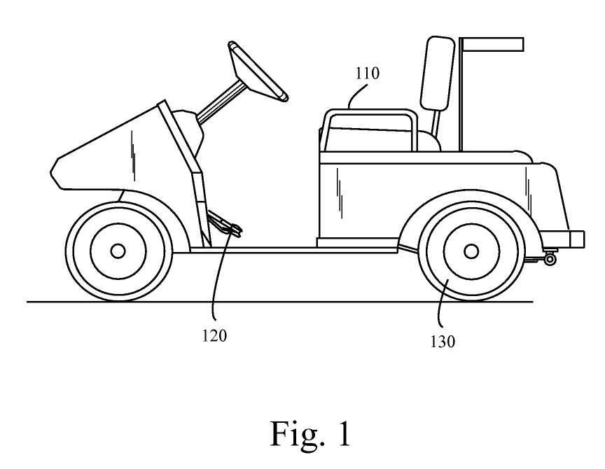

Representative embodiments according to the inventive subject matter are shown in FIGS. 1-9 wherein the same or similar features share common reference numerals. For clarity each reference number may refer to an item generally and abstractly, as well as instances of the item in the context of one or more embodiments.

The electric cart braking system shows a pedal attached to a pivot point and a brake cable adapter, the adapter also being connected to a master hydraulic cylinder, the hydraulic cylinder capable of driving four disc brakes. The electric cart braking system also describes a method for removing existing drum brakes and installing the hydraulic brakes. To aid in the installation of the brakes, a description of a kit is provided.

FIG. 1 is side view of the prior art 100 showing an outline view of a electric cart. In the electric cart a person is seated at the drivers seat 110 and uses his or her foot to operate the brake pedal 120. When the brake pedal 120 is depressed, a cable is tightened, causing the drum brakes to be pressed against a brake pad. The friction on the brake pad causes the axle to slow and the electric cart to decelerate.

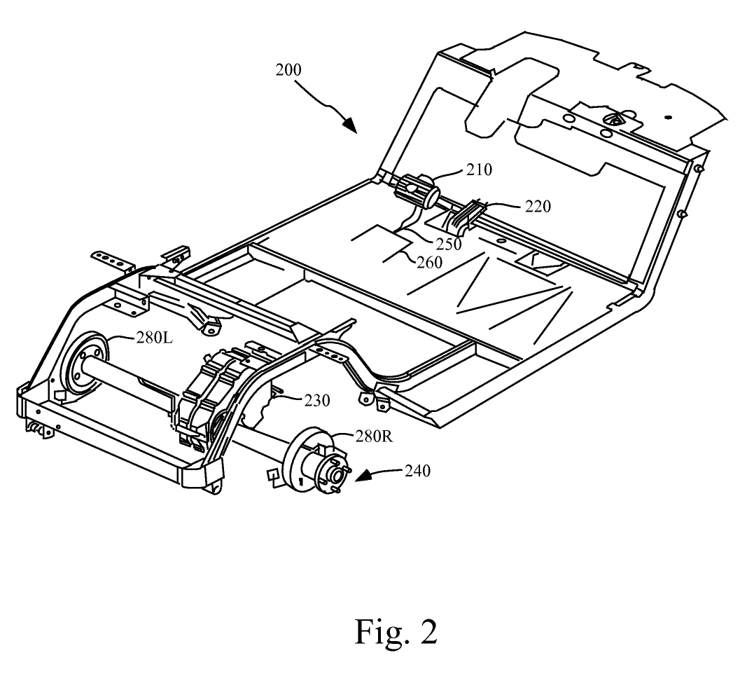

FIG. 2 is a prior art view of the configuration of the drum braking system and the cable connections between the brake pedals and the drum brakes. The brake pedal 210 is located towards the front section of the chassis 200 close to the acceleration pedal 220. The brake pedal 210 is linked to 260 to dual cable runs 270L, 270R which depress the brakes 280L,280R on the rear axle 240.

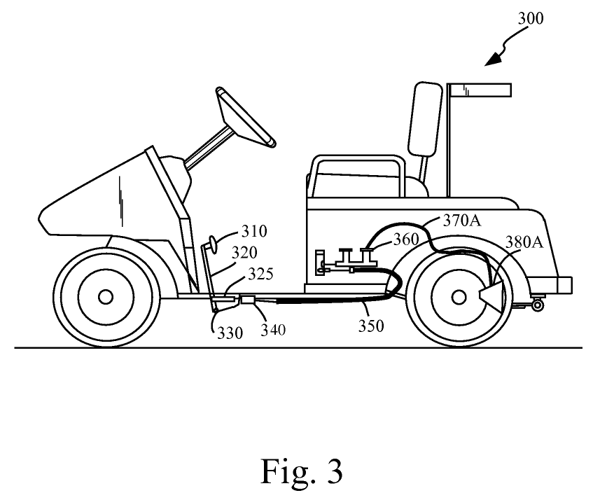

FIG. 3 is a side view of the modified braking system mounted on the electric cart 300. The brake pedal 310 is connected to a bar 320. The bar 320 is connected to brake pedal pivot point 330. Attached to the bar 320 is brake cable interface 325. The brake cable interface 325 is connected to the brake cable adapter 340. The brake cable adapter 340 is connected to a master cylinder brake line 350 which is then connected to the master cylinder 360. The master cylinder 360 is then connected by four hydraulic brake lines 370 to the disc brakes 380 (one braking system is shown at 370A, 380A). Disc brakes are well known in the arts consisting of a hydraulic fluid input and a braking element.

The modified braking system is operated when the rider of the electric cart 300 presses the brake pedal 310, which pulls the brake cable interface 325. The brake cable interface 325 pulls on the brake cable adapter 340 which then retracts one side of the cable inside of the master cylinder brake line 350. The other side of the master cylinder brake line 350 retracts pulling the piston interface to the master cylinder 360. The master cylinder 360 then ejects brake fluid into the hydraulic brake lines 370 causing the disk brakes 380A to actuate.

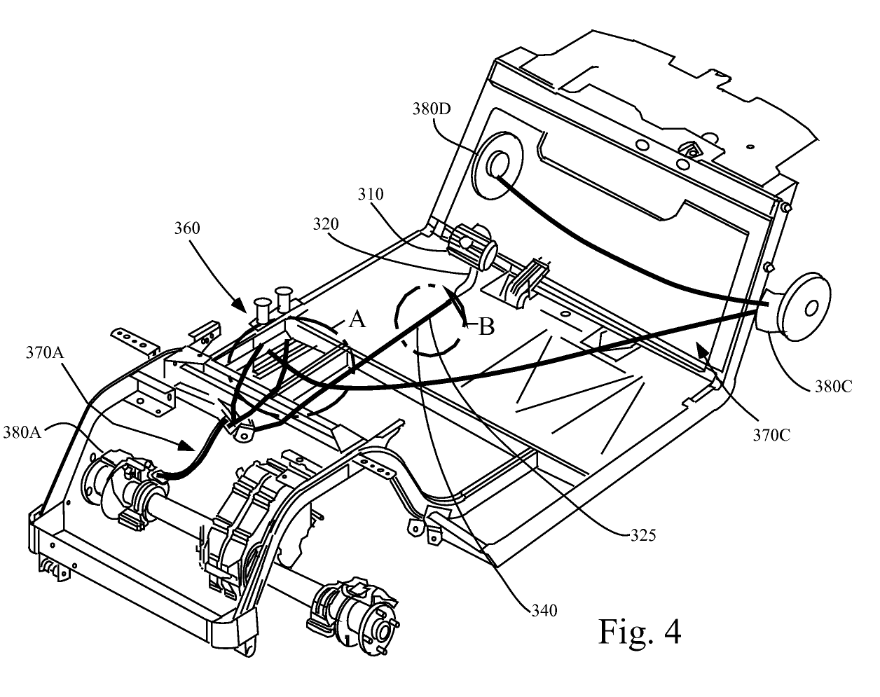

FIG. 4 is a top view of the modified braking system as shown in FIG. 3. Additional components are visible, for example, front brake lines 370C, in addition to front disk brakes 380C and 380D.

To install the modified braking system a number of individual modifications can be made to the electric cart to improve the installation of the modified system.

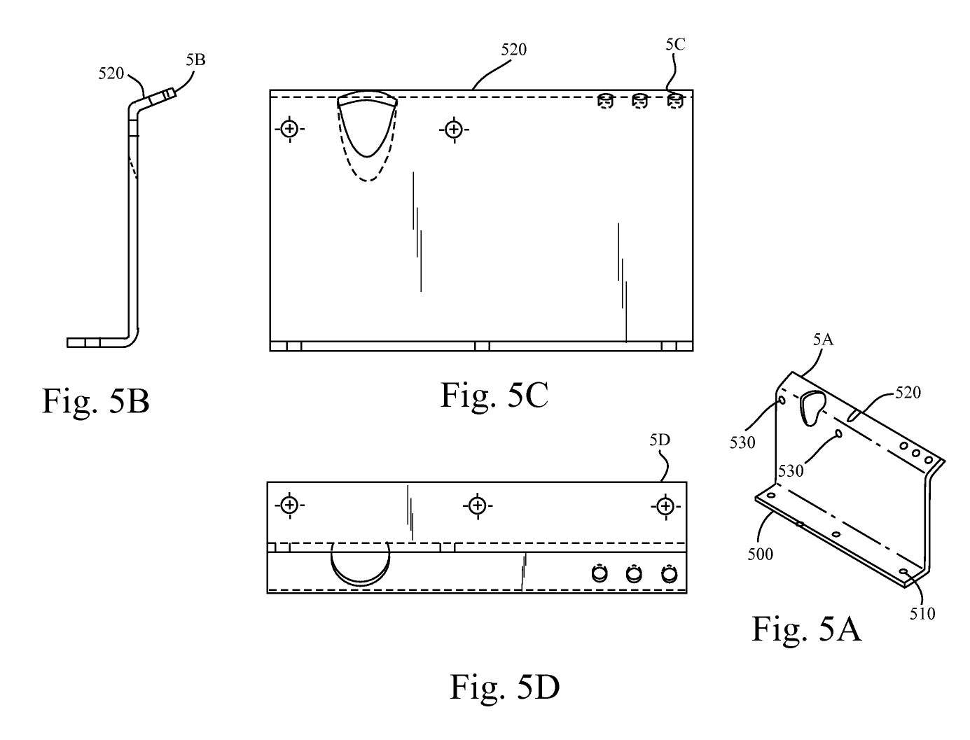

Now referring to FIG. 5 which depicts a master cylinder bracket 500 for installing the master cylinder 360. The master cylinder bracket is installed in the battery compartment (not shown) on the drivers side as shown in the detail area “A” of FIG. 4.

As shown in FIG. 5A which shows a side view of the master cylinder bracket 500 used to support master cylinder 360. The front edge of the master cylinder bracket 510 is oriented towards the front of the cart. The master cylinder 360 is attached (not shown) to the top 520 of the master cylinder 360 via mounting holes 530 on the master cylinder bracket 510.

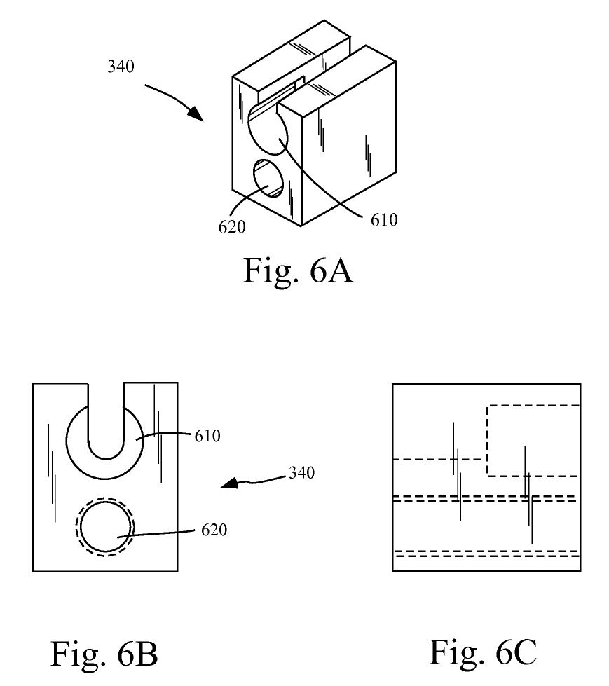

Now referring to FIGS. 6A, 6B, and 6C which shows in detail the brake cable adapter 340. The brake cable adapter 340 consists of an open slot 610 and a thread bore 620. FIG. 6B shows the front view of the cable adapter 340. FIG. 6C shows the side view of the brake cable adapter 340.

The installation of the brake cable adapter 340 involves removing the brake cable harness 260 as shown in FIG. 2 and installing the brake cable adapter 340 as shown in FIGS. 3 and 4.

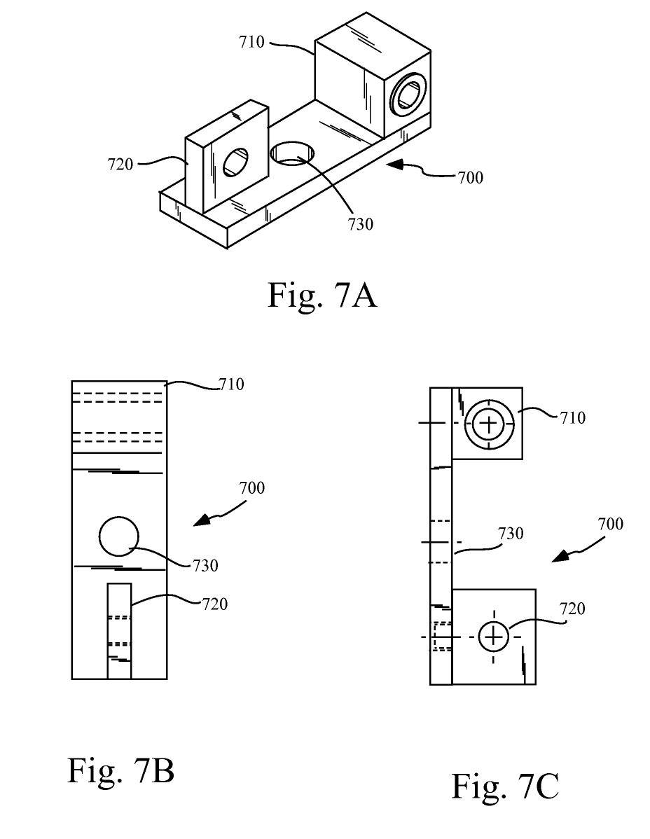

Now referring to FIGS. 7A, 7B, and 7C which shows in detail the pivot 700 installed on the master cylinder 360. The pivot 700 has pivot shaft 710 connected to the master cylinder 360. Opposite the pivot shaft 710 is a pivot hole 720 in which the clevis pins (not shown) are attached.

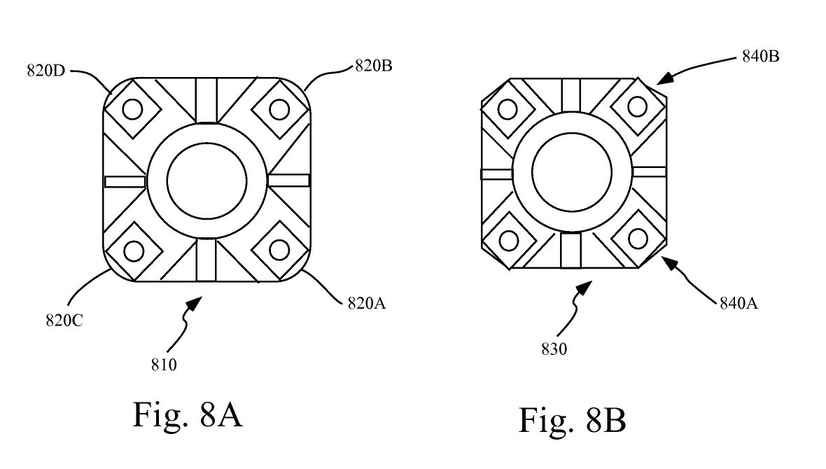

Now referring to FIG. 8A and 8B which show an unmodified rotor hat assembly (FIG. 8A) and a modified rotor hat assembly (FIG. 8B). FIG. 8A shows an unmodified rotor hat assembly 810 with rounded edges 820A, 820B, 820C, 820D. The unmodified rotor hat assembly is located on the front hubs of the electric cart. FIG. 8B depicts a modified rotor hat assembly 830. The modified rotor hat assembly differs from the unmodified motor hat assembly by the rounded corner edges cut to flat corner edges.

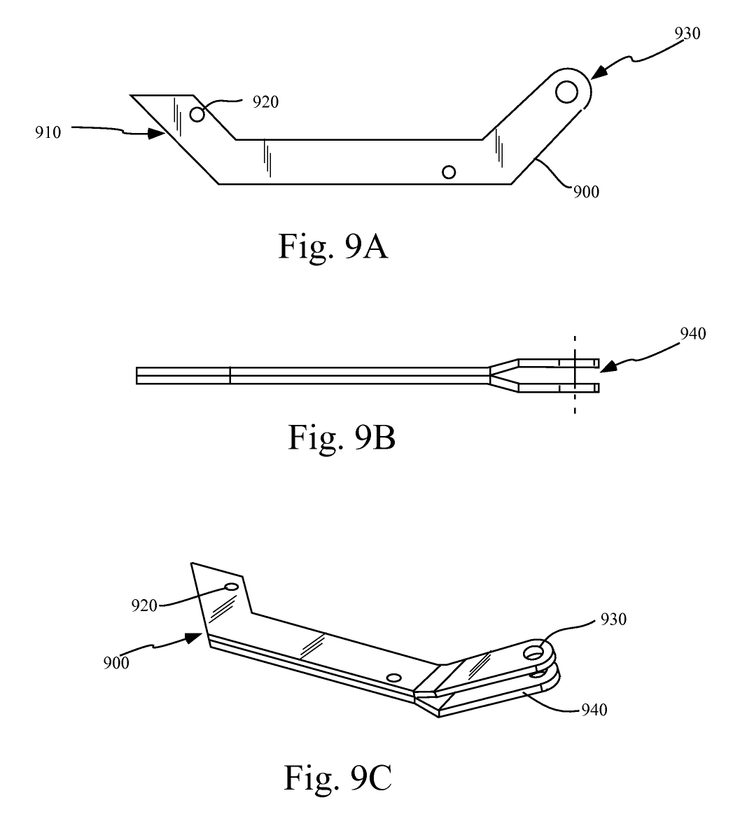

Now referring to FIG. 9A, 9B, 9C which is a push rod assembly 900. FIG. 9A is a side view of the push rod assembly showing the rod 910, the cylinder linkage point 920, and the brake linkage point 930. FIG. 9B is a top view of the push rod assembly showing a gap 940. The push rod assembly 900 provides an alternate linkage between the brake pedal 310 and the master cylinder 360.

In an alternate embodiment the stock front caliper mounts must be modified for use with certain axle by increasing the diameter of the caliper mount hole by ¼″.

The steps required to install each of the components can be done sequentially or where the steps may be optimized, in parallel. In certain cases, steps may be eliminated depending on the age and model of the electric cart. In the described embodiment, the components are installed in the electric carts manufactured by EZ-GO a subsidiary of Textron, Inc. The steps illustrated to retrofit the drum brakes to disk brakes are described as follows to provide a representative example of the installations.

In the first step, the electric cart is raised and all of the wheels are removed. The rear drum brakes with the backing plates are then removed to expose the rear axel. The brake cable harness is removed from beneath the electric cart.

Next the master cylinder mounting plate is installed in the rear battery compartment. The master cylinder mounting plate is oriented so the mounting plate holes are aligned with pre-drilled holes in the battery compartment. The plate is then attached with 5/16 bolts and washers. The master cylinder is then mounted onto the master cylinder mounting plate.

In the next step, the existing brake cable harness (previously detached) is removed and a threaded brake cable adapter is installed. The brake cable adapter is oriented so that the threaded rod is inserted in on one side and the existing brake cable is fitted into the slotted bore.

In the next step requires mounting the master cylinder rod to the pivot assembly. There are points of attachment using jam nuts that connect to the pivot assembly and the rod connecting the master cylinder.

The hubs are modified and installed in the next step. Each edge of the original hub is modified by altering the rounded edge to a flat edge.

The next step involves modification of the front wheel assembly. The front wheel assembly lacks a braking system upon design, so all that is required is the installation of a set of hydraulic brakes. The front spindles and the tie rod are removed. Modified front spindles are installed with new modified caliper mounts. The front calipers are attached to the mounts. Likewise, the rear calipers are attached to the mounts. Both the front and the rear brakes are then installed.

After the hydraulic brakes are installed, the hydraulic brake lines are then routed form the master cylinder to the front brake pair and the rear brake pair. A hydraulic line is connected from the master cylinder to one of the front brakes. A secondary line is then routed from the first front brake to the second front brake. Another hydraulic line is then routed to a rear brake. Another rear brake line is then routed from the first rear brake to the second rear brake.

The last step involves bleeding (e.g. removing air) from the brake lines. Bleeding involves the use of a pressure bleeder to remove the trapped air in the brake lines. The process of bleeding brakes is well known in the arts and typically consists of pressing the brake pedal a few times to expel the trapped gas.

The method of installing hydraulic brake systems on other electric cart systems would follow a similar process to the process just described for the installation on the EZ Go electric cart system.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

Currently claimed inventions:

1. An electric cart braking system, comprising:
a brake cable adapter having a first end and a second end, the first end of the brake cable adapter adapted to be mechanically connected to a pedal;
a hydraulic disk braking system having a piston input and one or more hydraulic braking elements; the piston input mechanically connected to the second end of the brake cable adapter,
wherein when a pedal is connected to the brake cable adapter and is depressed, the brake cable adapter is engaged, and the hydraulically operated disk brakes engages the hydraulic braking elements.

2. The electric cart braking system of claim 1 wherein there are four hydraulic braking elements.

3. The electric cart braking system of claim 1 wherein the brake cable adapter includes a threaded hole that is adaptable to be connected to the pedal.

4. The electric cart braking system of claim 1 wherein the brake cable adapter includes a slotted groove adaptable to be connected to the hydraulic braking system.

5. The electric cart braking system of claim 1 wherein the hydraulic disk braking system further comprises a master cylinder bracket and a base, the master cylinder bracket having a top portion and a bottom portion, wherein the top portion of the master cylinder bracket is fixedly attachable to a master cylinder and the bottom portion of the master cylinder bracket is attachable to the base.

6. The electric cart braking system of claim 1 wherein the hydraulically operated disk brakes further comprising a first rotor hat assembly and a second rotor hat assembly, the first rotor hat assembly and second rotor hat assembly each having two groups of four sides; wherein the first group four sides is longer and configured in box like structure; and wherein the second four sides is shorter and join the end points of each the first group of four sides; such that a square structure with flattened edges is formed.

7. The electric cart braking system of claim 1 wherein the brake cable adapter is a push rod assembly, wherein the push rod assembly is connectable to the pedal via a brake linkage point, a cylinder linkage point connected to the piston input, and a pivot point, wherein when the pedal is depressed the brake linkage point is rotated forward causing the cylinder linkage point to rotate about the pivot point causing the piston input to be engaged.

8. The electric cart braking system of claim 1 further comprising a first rotor hat assembly and a second rotor hat assembly, the first and second rotor hat assemblies having two groups of four sides; wherein the first group of four sides is longer and is configured in a box like structure; and wherein the second of four sides are shorter and join the end points of each the first group of four sides; such that a square structure with flattened edges is formed.

9. An electric cart brake modification kit comprising:
at least two hydraulic brakes, and a brake cable adapter having one end adaptable for connecting to a pedal and the other end adaptable for connecting to the hydraulic brakes.

10. The electric cart brake modification kit of claim 9 further comprising a master cylinder mounting plate.

11. The electric cart brake modification kit of claim 9 further comprising a rotor hat assembly wherein the edges are modified to round the corner edges for installation on a hub.

12. The electric cart brake kit of claim 9 further comprising four hydraulic brakes.

13. The electric cart brake kit of claim 9 further comprising a front caliper mount modified by increasing the caliper mount hole.

14. A method of retrofitting a electric cart braking system, comprising
removing a drum brake cable interface; removing a drum brakes from an axle; installing a drum brake cable adapter between the pedal and a hydraulic brake system; installing the hydraulic brake system, wherein the hydraulic brake system includes a hydraulic master cylinder and at least two hydraulic disc brakes; and connecting hydraulic brake lines from the hydraulic master cylinder to the hydraulic disc brakes.

15. The method of retrofitting a electric cart braking system of claim 14 further comprising: locating the brake cable harness, wherein the brake cable harness has three attachment points, the attachment points connected to a pedal and each of the drum brakes; disconnecting first attachment point of the brake cable harness the pedal; disconnecting the other side of the drum brake cable from the two drum brakes; installing a brake cable adapter, where the brake cable adapter is connected to the pedal and the hydraulic brake system; connecting the first connection point of the brake cable adapter to the pedal; and connecting the second connection point to the hydraulic master cylinder.

16. The method of retrofitting an electric cart braking system of claim 16 further comprising:
removing a first wheel from an axel and removing a second front wheel from an axel; removing a first unmodified hub from the axel and removing second modified hub from the axle; altering the corner to a planar surface of the first unmodified hub and altering the corner to a flat surface of the second modified hub by transforming the edges from a rounded surface to a planar surface; and installing the first modified hub and the second modified hub on the axle.

17. The method of retrofitting an electric cart braking system of claim 14 further comprising the step of installing four hydraulic brakes.

18. The method of retrofitting an electric cart braking system of claim 14 further comprising the step of installing a push rod assembly between the pedal and the hydraulic brake system.

19. The method of retrofitting an electric cart braking system of claim 14 further comprising the step of installing a front caliper mount on an axle.

20. The method of retrofitting an electric cart braking system of claim 14 further comprising the step of installing a master cylinder mounting assembly.
